(19) United States
(12) Patent Application Publication
(10) Pub. No.: US 2026/0202617 A1
(43) Pub. Date: Jul. 16, 2026

(54) EXPANDED BEAM CONNECTORS AND METHODS OF MANUFACTURING THE SAME

(71) Applicant: CORNING RESEARCH & DEVELOPMENT CORPORATION, CORNING, NY (US)

(72) Inventors: Mark Alan Bradley, Nellysford, VA (US); Scott Robertson Bickham, Corning, NY (US); Xin Chen, Painted Post, NY (US); Qijun Xiao, Fremont, CA (US); Shudong Xiao, Fremont, CA (US); Lei Yuan, Painted Post, NY (US); Andy Fenglei Zhou, Fremont, CA (US)

(21) Appl. No.: 19/565,719

(22) Filed: Mar. 13, 2026

Related U.S. Application Data
(63) Continuation of application No. PCT/US2024/044370, filed on Aug. 29, 2024.
(60) Provisional application No. 63/538,131, filed on Sep. 13, 2023.

(51) Int. Cl. G02B 6/255; G02B 6/38

(52) U.S. Cl. CPC G02B 6/2558; G02B 6/3883; G02B 6/3885

(57) ABSTRACT

In embodiments, an expanded beam connector includes a mechanically spliced optical fiber and a support body defining a fiber channel. The mechanically spliced optical fiber includes a first optical fiber, wherein the first optical fiber is a multi-mode fiber having a first end, a second end, and a fiber length extending between the first end and the second end, and a second optical fiber mechanically spliced to the first end of the first optical fiber at a splice connection, the second optical fiber being a single-mode fiber. The splice connection is supported within the fiber channel. The fiber length is an odd multiple of a quarter-pitch length and is greater than 0.1 mm and less than 5.0 mm.

### RELATED APPLICATIONS

This application is a continuation of International Patent Application No. PCT/US2024/044,370, filed Aug. 29, 2024, which claims the benefit of priority of U.S. Provisional Application Ser. No. 63/538,131, filed Sep. 13, 2023. The content of each aforementioned priority application is relied upon and incorporated herein by reference in its entirety.

### FIELD

The present specification generally relates to expanded beam connectors and methods of manufacturing the same, and more particularly, expanded beam connectors having mechanically spliced optical fibers.

### BACKGROUND

Benefits of optical communication include extremely wide bandwidth and low noise operation. Because of these advantages, optical fiber is increasingly being used for a variety of applications, including, but not limited to, broadband voice, video, and data transmission. Connectors are often used in data center and telecommunication systems to provide service connections to rack-mounted equipment and to provide inter-rack connections. Accordingly, optical connectors are employed in both optical cable assemblies and electronic devices to provide an optical-to-optical connection wherein optical signals are passed between an optical cable assembly and an electronic device.

Optical devices, such as optical connectors, may include optical elements secured, for example, to the v-grooves of a substrate or secured into the micro-holes of a ferrule. The optical connectors may then be connected to another optical device to provide optical communication between optical devices. For optimal data communication between optical connectors, the optical fiber connectors need to be aligned to accurately and efficiently transmit the data between the optical fibers of the connectors. Coupling losses between two optical connectors may occur due to lateral or angular misalignments of the optical fibers relative to the center of the v-grooves or micro-holes and/or variations in the pitch of the optical fibers. In addition, the optical fibers need to be in physical contact with the optical element to which it is coupled to ensure that there is no degradation of the insertion loss and return loss performance. Often physical contact or coupling may be achieved via fusion splicing. However, fusion splicing is often time-consuming, cost prohibitive, and may lead to localized disturbance of index distribution within the resulting combined fiber.

### SUMMARY

Embodiments of the present disclosure are directed toward expanded beam connectors, which use a mechanical coupling as opposed to fusion splicing processes to couple optical components of a connector thereby providing, lower cost, faster processing, while avoiding localized disturbances caused by fusion splicing.

In one embodiment, an expanded beam connector includes a mechanically spliced optical fiber and a support body defining a fiber channel. The mechanically spliced optical fiber includes a first optical fiber, wherein the first optical fiber is a multi-mode fiber having a first end, a second end, and a fiber length extending between the first end and the second end, and a second optical fiber mechanically spliced to the first end of the first optical fiber at a splice connection, the second optical fiber being a single-mode fiber. The splice connection is supported within the fiber channel. The fiber length is an odd multiple of a quarter-pitch length and is greater than 0.1 mm and less than 5.0 mm.

In another embodiment, a method of manufacturing an expanded beam connector includes inserting a first length of a first optical fiber into a fiber channel formed within a support body, while within the fiber channel, cleaving the first length of the first optical fiber to provide a second length of the first optical fiber extending between a first end and a second end, the second length being a multiple of a quarter-pitch length, inserting a second optical fiber into the fiber channel to abut the second optical fiber with the second end of the first optical fiber at a splice connection, and sliding the first end of the first optical fiber to a final position with the second optical fiber such that the splice connection remains within the fiber channel at the final position.

In yet another embodiment, an expanded beam connector includes an array of mechanically spliced optical fibers and a support body defining an array of fiber channels. Each mechanically spliced optical fiber includes a first optical fiber, wherein the first optical fiber is a multi-mode fiber having a first end, a second end, and a fiber length extending between the first end and the second end, and a second optical fiber mechanically spliced to the first end of the first optical fiber at a splice connection, the second optical fiber being a single-mode fiber. The splice connection of each of the mechanically spliced optical fibers is supported within a respective fiber channel of the support body. The fiber length is an odd multiple of a quarter-pitch length and is greater than 0.1 mm and less than 5.0 mm.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts optical communication between expanded beam connectors, according to one or more embodiments shown and described herein;

FIG. 2 schematically depicts an optical assembly including an expanded beam connector, according to one or more embodiments shown and described herein;

FIG. 3 schematically depicts a support body of the optical assembly, according to one or more embodiments shown and described herein;

FIG. 4 schematically depicts a flow chart illustrating a method of manufacturing an expanded beam connector, according to one or more embodiment shown and described herein;

FIG. 5A schematically depicts forming one or more perforations on a first optical fiber such as with a laser, according to one or more embodiments shown and described herein;

FIG. 5B schematically depicts cleaving a first end of the first optical fiber of FIG. 5A at a first location, according to one or more embodiments shown and described herein;

FIG. 5C schematically depicts inserting the first optical fiber into a fiber channel of a support body, according to one or more embodiments shown and described herein;

FIG. 5D schematically depicts cleaving a portion of the first optical fiber extending external to the support body, according to one or more embodiments shown and described herein;

FIG. 5E schematically depicts inserting a second optical fiber into the fiber channel of the support body of FIG. 5D to abut the first optical fiber, according to one or more embodiments shown and described herein;

FIG. 6 schematically depict an expanded beam connector, wherein the support body includes a grooved tray, according to one or more embodiments shown and described herein;

FIG. 7 schematically depicts an expanded beam connector, wherein the support body includes a grooved tray, according to one or more embodiments shown and described herein; and

FIG. 8 schematically depicts a distribution of 5/4 pitch lengths for randomly selected multi-mode fibers, according to one or more embodiments shown and described herein.

### DETAILED DESCRIPTION

Embodiments of the present disclosure are directed to expanded beam connectors and methods of manufacturing the same. In particular, in embodiments, a mechanically spliced optical fiber is formed from a first optical fiber (e.g., a multi-mode fiber, hereinafter “MMF”) and a second optical fiber (e.g., a single-mode fiber, hereinafter, “SMF”) and is provided as part of the expanded beam connector. The MMF and SMF are mechanically spliced to one another such as via a butt joint, the spliced joint being supported within a fiber channel of a supporting body (e.g., such as a ferrule, V-groove plate, or similar structure). By mechanically splicing the MMF and SMF, many of the pitfalls of fusion splicing are avoided. In particular, fusion splicing tends to be of high cost, time consuming, and can lead to localized disturbances thereby effecting data transmission quality. Embodiments as provided herein provide lower cost, faster processing, while avoiding localized disturbances caused by fusion splicing

For example, in high-density channel applications, connectors often need 12 to 36 channels (e.g., fibers) oriented parallel to one another with a predetermined pitch. In some applications, the channels are comprised of two linear arrays of fibers which are fusion spliced to each other using a mass fusion splicer. Should the fusion splices between any pair of fibers in the two linear arrays fail, the entire unit is rendered inoperable. The mass fusion splicers tend to be costly and need regular maintenance to replace electrodes and calibrate fusion recipes, adding more cost. Finally, fusion splicing essentially involves melting and then joining two fibers. Such processing may lead to localized disturbance of index distribution within an optical fiber. Additionally, fusion splicing may cause localized swelling, making insertion into the small channels of a ferrule or tray difficult. Mechanical splicing may avoid these issues completely. Additional features and embodiments will be described in greater detail below.

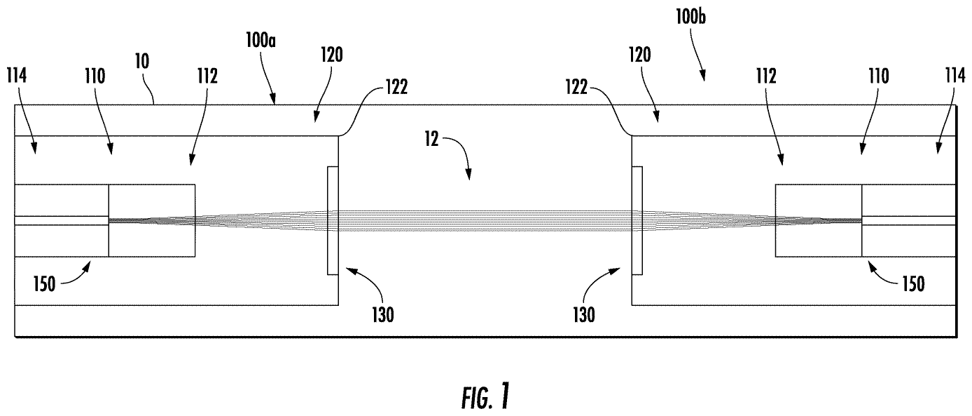

Optical fibers may be manipulated to collect, guide or transmit propagating photonic information in communication devices. FIG. 1 illustrates optical communication occurring between a first expanded beam connector 100a and a second expanded beam connector 100b. It is noted that optical communications need not occur between two expanded beam connectors as provided herein, but between an expanded beam connector and any optical communication device. In the illustrated embodiment, the expanded beam connectors 100a, 100b are received within an adaptor 10, which may hold the expanded beam connectors relative to one another and in alignment for communication of an optical signal 12, such as via non-contact communication between optical connectors 100a, 100b. As will be described in detail herein, an expanded beam connector may include a mechanically spliced optical fiber 110, and a support body 120. In embodiments, a connector end face 130 may be positioned within, on, or otherwise form part of the support body 120, such as at an end 122 of the support body 120.

The mechanically spliced optical fiber 110 may include a first optical fiber 112, wherein the first optical fiber 112 is an MMF, such as a gradient-index MMF. The first optical fiber 112 may provide a gradient-index (GRIN) lens. As may be understood, the length of the first optical fiber determines the output characteristic of an expanded beam. In order to provide a consistent output characteristic for all of the optical fibers within the expanded-beam connector 100, the MMF GRIN lens needs to be trimmed to an accurate fiber length. The MMF length may be a multiple of a quarter-pitch length. A quarter-pitch length is defined by the actions of the light propagating within the MMF GRIN lens. Notably, at a quarter-pitch length, the signal or wave transmission exits the optical fiber in a configuration different than the signal entered the optical fiber (e.g., enters collimated exits focused; enters focused exits collimated and/or expanded). In the depicted embodiment, the optical signal 12 is expanded through the first optical fiber 112 of the first connector 100a while the optical signal 12 received from the first connector 100a by the second connector 100b and is focused into the second optical fiber 114, though other configurations are contemplated and possible.

The quarter-pitch length accounts for a maximum relative refractive index, the core radius, and the core curvature. Using these factors the quarter-pitch length may define a tolerance of ±10 microns, such as ±5 microns. The small variation allows similar MMFs to be used to create a precision-length GRIN lens (particularly at scale), where the signal exiting from the MMF GRIN lens is an expanded beam, for each element of the expanded-beam connector 100. In this regard, providing for small variation allows for a single cut for all fibers to occur (e.g., at a multiple of the quarter-pitch length) that still results in desired performance by all of the fibers in an expanded-beam connector-thereby allowing for scalability of production while ensuring common signal characteristics at a first end of the fiber. Quarter pitch lengths and production will be discussed in greater detail below.

The second optical fiber 114 may be a single mode fiber SMF. The single mode fiber supports only one linearly-polarized (LP01) mode per polarization direction at a system wavelength. In various embodiments the second optical fiber 114 may have a longer length than the first optical fiber 112. That is, the first optical fiber 112 may be a GRIN lens spliced to an end of the second optical fiber 114.

The first optical fiber 112 and the second optical fiber 114 may be coupled one another via a mechanical splicing, such as via a butt joint at a splice position, to provide a splice connection 150. In some embodiments, an adhesive (e.g., an optical adhesive) may be used to maintain a position of the first optical fiber relative to the second optical fiber 114. For example, adhesives may include, but are not limited to, commercially available adhesives from EMI-UV™, Norland™, Epotek®, Addison Clear Wave Coatings, Inc.™, NTT-AT™. For example, EMI-UV OPTOCAST-3553 series is a UV curable bonding epoxy, and NTT 8224AT is an index matching epoxy. As noted herein above, mechanical couplings may have several advantages over fusion processing as discussed in detail above in particular avoiding localized disturbances causes by heating during fusion splicing.

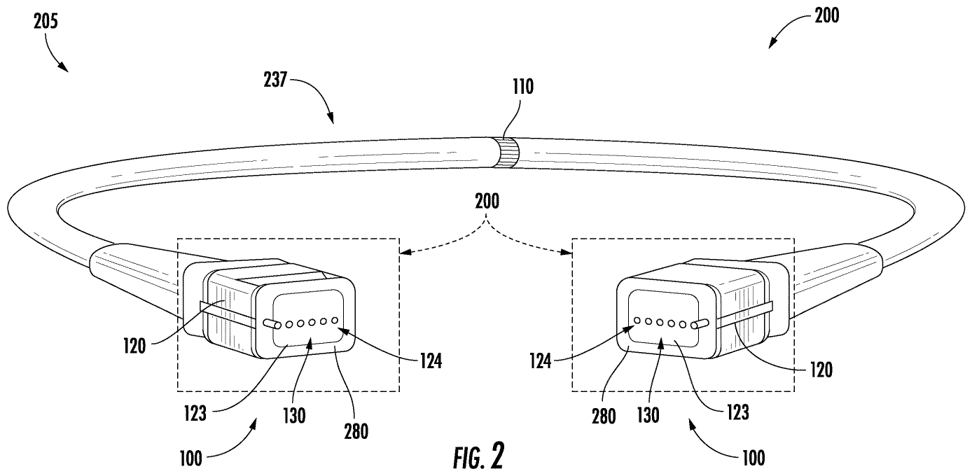

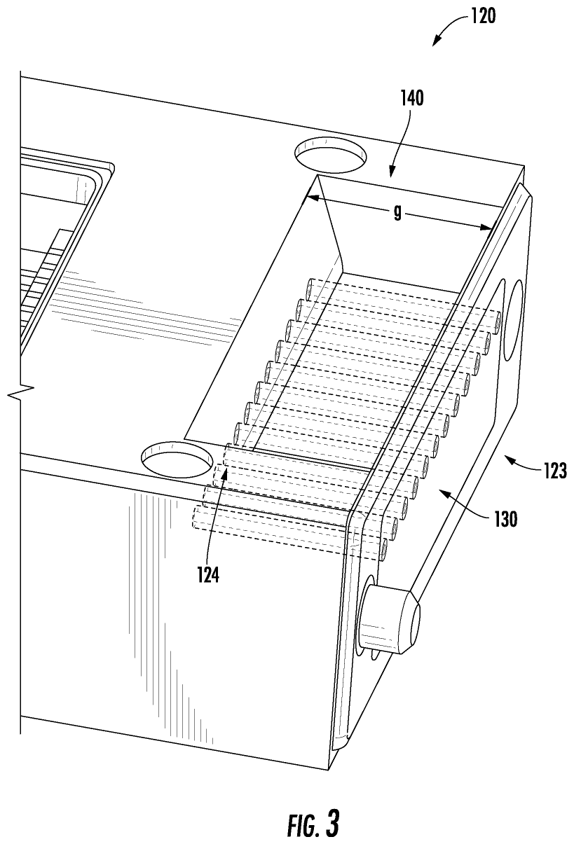

FIG. 2 illustrates an embodiment of a cable assembly 200. The cable assembly 200 may include the mechanically spliced optical fiber 110, such as a plurality of mechanically spliced optical fibers (e.g., 2 or more mechanically spliced optical fibers, 6 or more mechanically spliced optical fibers, 12 or more mechanically spliced optical fibers, etc.), which may be contained within an outer cable layer 237 or jacket (e.g., polymer jacket or the like). The mechanically spliced optical fiber 110, may extend between two or more connectors 100 each of which includes a support body 120, which may include a ferrule 123, or, as will be described in greater detail below, a grooved plate, such as a v-groove plate. The connectors 100 may include additional structure without departing from the scope of the present disclose. The ferrule 123 may include at least one channel 124 (e.g., micro-channel), such as an array of ferrule channels (best depicted in FIG. 3), each, or a portion thereof, receiving a mechanically spliced optical fiber 110. Referring to FIG. 1, the connector end face 130 may be spaced from an end of the first optical fiber 112 (as depicted) or abutted with the connector end face 130. In embodiments, the spacing may be less than 10 mm, such as less than 5 mm, such as less than 3 mm, such as less than 2 mm, which may assist in optimizing the divergence (e.g., spreading) of light as it exists the first optical fiber 112. Similarly, such spacing may be useful in a receiving connector for focusing incoming light.

FIG. 3 depicts the support body 120, depicting at least one channel 124, in this case, a plurality of channels. Across from or at an end of each channel 124 may be a connector end face 130. Separating the connector end face 130 from the at least one channel may be a transverse channel 140 providing a gap, g, between an end of the channel 124 and the respective connector end face 130.

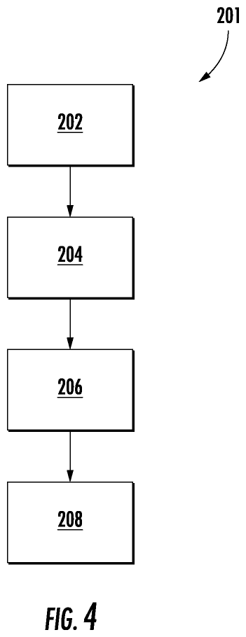

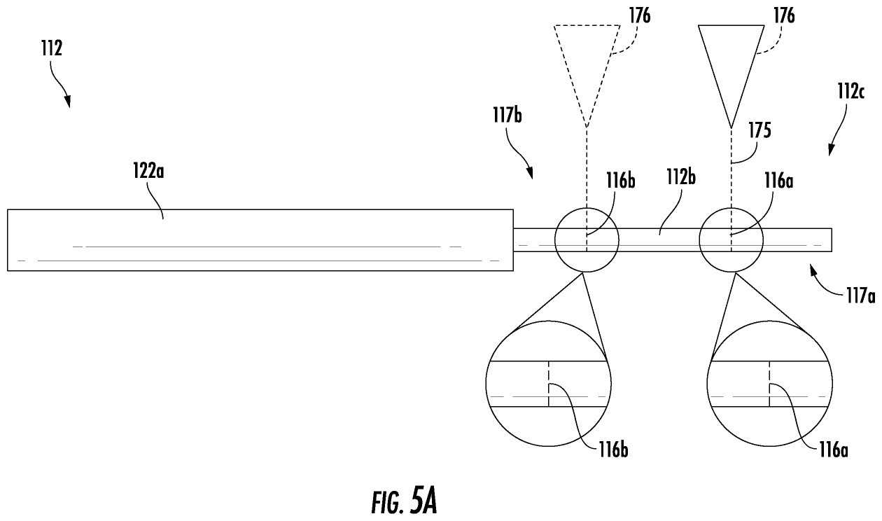

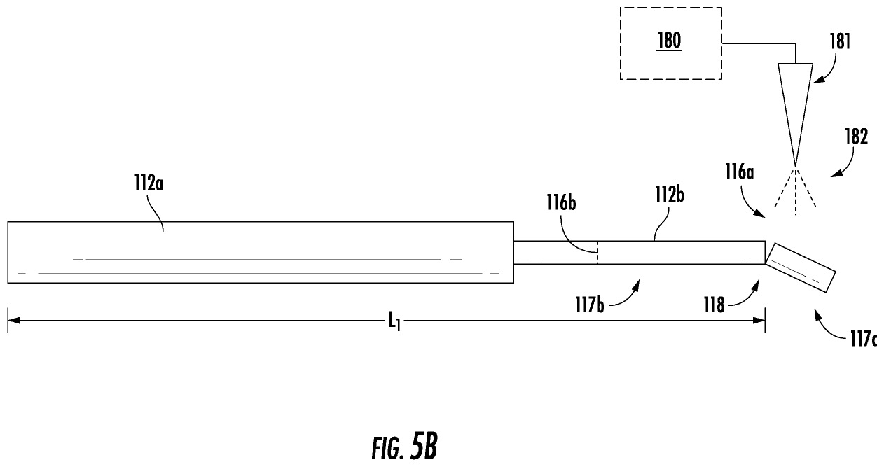

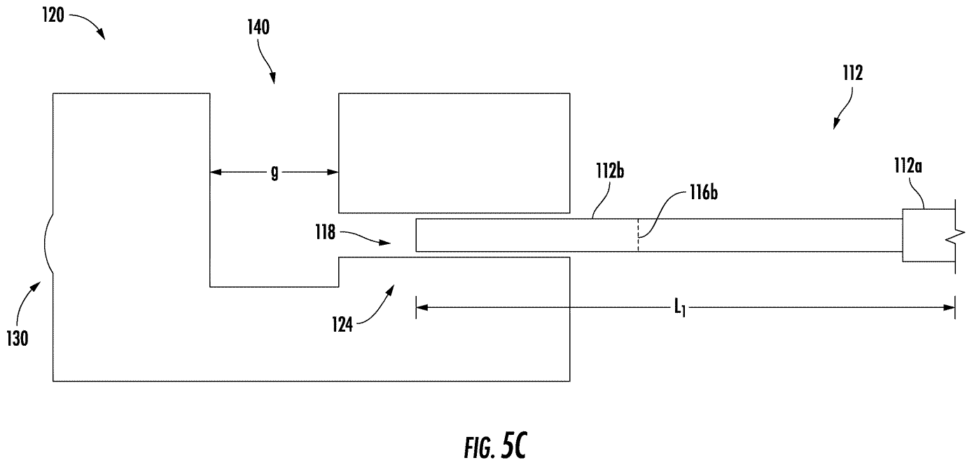

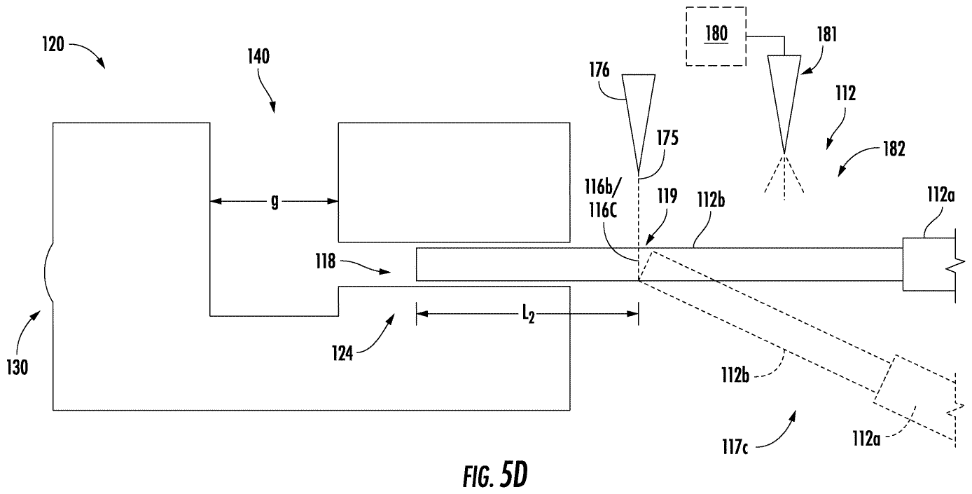

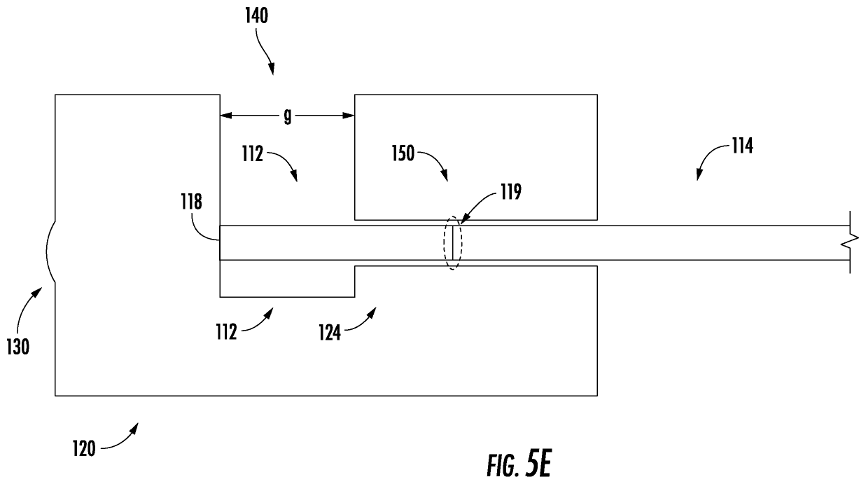

Referring now to FIG. 4, a method of manufacturing an expanded beam connector 100, such as described above, is generally depicted. Though the method 201 is shown with a number of steps in a particular order, the method 201 may include a greater or fewer number of steps, which may be performed in any order. Moreover, the method 201 may be further understood with respect to FIGS. 5A-5E.

Returning to FIG. 4, at block 202, the method 201 includes inserting a first length of the first optical fiber 112 into the fiber channel 124 formed within the support body 120. Several steps may be taken in preparation of inserting the first length of the first optical fiber 112 into the fiber channel 124. For example, a fiber which is to be used as the first optical fiber 112, may first be cleaved or separated from a ribbonized array of fibers, or from a spool of fibers. It is noted that there may be advantages of one over the other. For example, a ribbonized array of fibers may include a plurality of fibers arranged side-by-side in an array, such that single cleaving actions may be taken, to prepare a plurality of first optical fibers. However, there may be fiber to fiber variations, such that the length needed for each fiber in a ribbon may not be equal (unless in creation of the ribbon very tight distributions of refractive indexes were controlled for). On the other hand, using a single spool, optical properties for the fiber may be taken from samples of the spool of fiber used to create the quarter pitch lengths of the first optical fiber 112, which may allow for the same quarter pitch length determination for the entire spool. Embodiments of the present disclosure contemplate both instances.

In any case, in embodiments, preparation of the first optical fiber 112 may include, stripping an outer jacket 112a (such as a polymer jacket) away to thereby expose a cladding 112b of the first optical fiber 112, the cladding 112b may surround a core of the optical fiber 112. In some embodiments, to ensure end quality a first end portion 112c of the optical fiber may be cleaved or removed prior to insertion into the fiber channel 124. For example, a first end portion 112c of the first optical fiber 112 may be precision laser cleaved.

For example, and with reference to FIG. 5A, a laser 176 may produce a laser beam 175 and may translate across the first optical fiber 112 to yield first perforations 116a through the cladding 112b of the first optical fiber 112. The first perforations 116a may divide the first optical fiber 112 into an excess portion 117a and a remaining portion 117b of the first optical fiber 112.

In embodiments, the laser 176 may be a femtosecond laser, while in other embodiments, the laser 176 may be a diode-pumped laser, a nanosecond laser, or the like. In some embodiments, the laser beam 175 may have a central wavelength between 900-1100 nm, between 950-1080 nm, and between 980-1040 nm. In some embodiments, the laser beam 175 may have a pulse width between 5-20 picoseconds, between 7-15 picoseconds, and between 9-11 picoseconds. In some embodiments, the laser beam 175 may have a repetition rate between 35-75 kHz, between 45-65 kHz, and even between 47-62 kHz. In an example embodiment, the laser beam 175 may have a central wavelength of 1030 nm, a pulse width of 10 picoseconds, and a repetition rate of 50 KHz.

In some embodiments, the laser beam 175 may define a pulse yielding 160 μJ. The laser 176 may be configured such that the laser beam 175 produced is approximately 1 μm wide and 1 mm long. The laser 176 may further be configured to move with a translation rate across the uncut first optical fiber 112 of 20 mm/s. The translation rate may provide evenly spaced perforations 116 across the cladding 112b of the first optical fiber 112.

The laser 176, or a second laser, which may be identical to or different to the laser 176, may be moved or positioned to translate across the optical fiber to yield second perforations 116b at a second location. The perforations may be sized the same or differently relative to first perforations 116a. For example, perforations 116a, may be positioned closer together than perforations 116b. For example, perforations 116a may be positioned relative to one another at a 2.4 μm, while perforations 116b may have a greater pitch so as to just provide a few holes which may be used as markers for marking a cleaving location for a later cleaving action, described further below. That is, the method 201 may include forming one or more markings, marking a cleaving location.

In an alternative embodiment, a parallel diamond cutter may be used to perforate the first optical fiber 112 at the first perforation 116a and/or the second perforation 116b. Other perforating techniques are contemplated and possible.

As illustrated in FIG. 5B, after the first perforations 116a are formed a force 182 may be applied to the excess portion 117a to remove the excess portion 117a from the remaining portion 117b. That is application of force is used to break away the excess portion 117a from the remaining portion 117b at the first perforations 116a. In some embodiments, the force 182 may be in the form of compressed gas from a gas supply 180 dispensed from a nozzle 181. In some embodiments, the force 182 may be applied at a pressure between 15-65 psi, between 25-55 psi, or between 35-45 psi. In some embodiments, the external force is applied for between 50-500 ms, between 100-400 ms, or between 150-300 ms. In an example embodiment, the force 182 may be compressed air applied to the excess portion 117a at pressure of 40 psi, for about 200 ms. In some embodiments the force 182 is translated across the excess portion 117a, while in other embodiments, the force 182 is configured to contact the entire excess portion 117a.

The application of the force 182 to remove the excess portion 117a results in the first optical fiber 112 having the first length, L₁, which may then be inserted into the fiber channel 124 formed within the support body 120, as depicted in FIG. 5C. By removing the excess portion 117a, surface quality of new first end 118 may be ensured. In some embodiments, further processing of first end 118 may include polishing, shaping, or trimming. The first length, L₁, may be inserted a sufficient distance into the fiber channel 124 such that the second perforations 116b are positioned external to the fiber channel 124. Stated another way, the first end 118 may be supported within the support body 120, such as within the fiber channel 124.

Referring again to FIG. 4, at block 204, the method 201 further includes, while within the fiber channel 124, cleaving the first length, L₁, of the first optical fiber 112 to provide a second length, L₂, of the first optical fiber 112. For example, the second perforations 116b may be used to mark a location for cleaving the first length, L₁, of the first optical fiber 112 into the second length, L₂. Referring to FIG. 5D, the laser 176, second laser, or yet another laser, may be used to cleave the first optical fiber 112 at the second perforations 116b. For example, third perforations 116c may be formed over the second perforations 116b, similar to the pitch of the first perforations 116a, and a force, such as force 182 described above, may be used to break off remaining portion 117c, thereby leaving the second length, L₂, within the fiber channel 124.

As noted above, the first optical fiber acts a GRIN lens. The GRIN length is a multiple, such as an odd multiple of a quarter pitch length (e.g., 1/4 pitch length, 3/4 pitch length, 5/4 pitch length, 7/4 pitch length, etc.). In the illustrated embodiment, first end 118 of the first optical fiber 112 is directed toward the connector end face 130 and second end 119 of the first optical fiber 112 is positioned away from the connector end face 130. The second end 119 may form part of the splice connection 150. Accordingly, as the second end 119 will be mechanically spliced to the second optical fiber 114, it may be beneficial to ensure the second end 119 remains supported within the fiber channel 124, thereby ensuring the splice connection 150 is supported within the fiber channel 124. Accordingly, the odd multiple of the quarter pitch length would, preferably, place the second end 119 of the first optical fiber 112 within the fiber channel 124, when all the way inserted as described in greater detail below.

Referring again to FIG. 4, at block 206, the method 201 may include inserting the second optical fiber 114 into the fiber channel 124 to abut the second optical fiber 114 with the second end 119 of the first optical fiber 112 at a mechanical splice position 150 (e.g., in contact with the second end of the first optical fiber). In embodiments, in preparing the second optical fiber 114, a similar cleaving procedure may be performed on the second optical fiber 114 to provide a clean mating end for mechanical splicing. That is the second optical fiber 114 may be stripped and cleaved, such as laser cleaved with a laser as described above.

At block 208, the method 201 may include sliding the first end 118 of the first optical fiber 112 to a final position with the second optical fiber 114 such that the mechanical splice connection 150 remains within the fiber channel 124 at the final position, such as illustrated in FIG. 5E. That is, the connection 150 remains supported or housed within the channel 124. Accordingly, the support body 120 may provide restraints to the mechanical splice connection 150 or joint. As depicted, in some embodiments, sliding the first end 118 to a final position, places the first end 118 outside of the fiber channel 124, such as within transverse channel 140. In embodiments, accordingly, the first optical fiber may be at least partially suspended within the transverse channel 140. In some embodiments, the method 201 may further include applying or supplying adhesive (such as an optical adhesive) to the mechanical splice connection 150 or to the fibers 112, 114 to fix the first optical fiber to the second optical fiber at the mechanical splice connection 150.

It is further noted that while assembly is illustrated as to only one fiber channel 124, the same procedural steps may be taken for each fiber within each fiber channel 124 where there is an array of fiber channels, such as illustrated in FIGS. 2 and 3. Accordingly, the connector 100 may include an array of mechanically spliced optical fibers 110.

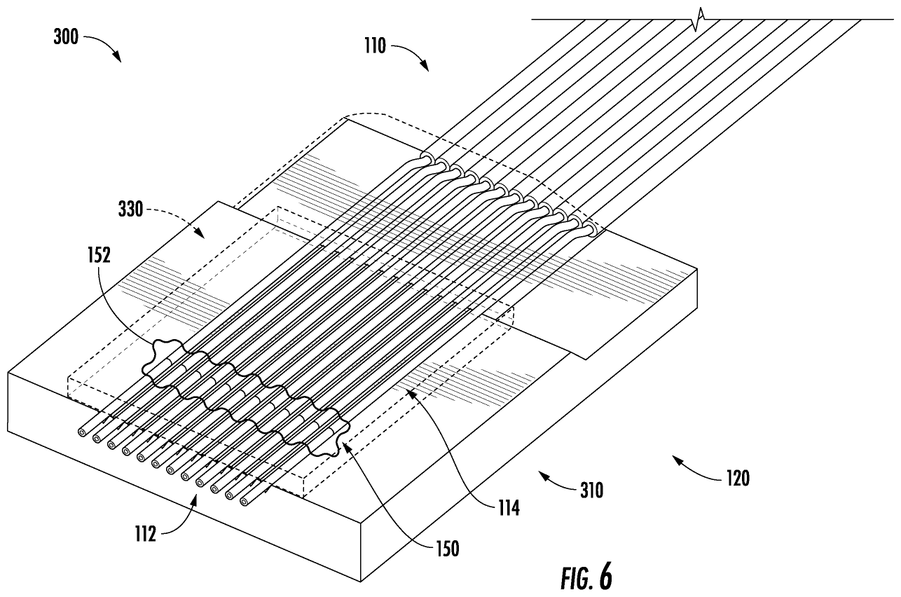

As noted above, in some embodiments, instead of a ferrule, a tray, such as a v-groove tray may be used as the support body 120. For example, and with reference to FIG. 6, an expanded beam assembly 300 may include a tray 310 which provides one or more, such as a plurality of grooves 312 providing fiber channels 124. The grooves may have any shape, such a semi-cylindrical grooves, V-grooves, rectangular grooves, or the like. The assembly may further include a lid 330 extending over the grooves 312. The tray may be formed of any suitable material (e.g., plastic, glass, ceramic, etc.).

In the depicted embodiment, the mechanically spliced optical fibers 110 may be formed using substantially the same process as described above and may include first optical fiber 112 and a second optical fiber 114, spliced together as described above at a splice connection 150. Similarly, an adhesive 152, such as an optical adhesive may be disposed over the splice connection 150 or over portions of the first optical fiber 112 and the second optical fiber 114 to prevent movement of the fibers 112, 114 relative to one another at the mechanical splice connection 150.

In embodiments, the lid 330, which may be formed of the same or different material from the tray 310, may be positioned over the grooves during cleaving and/or application of adhesive to hold the fibers 112, 114 relative to one another. In other embodiments, such steps may occur without the lid 330 in place. Additionally, the present embodiment, illustrates a plurality of mechanically spliced optical fibers 110 as part of a ribbonized array of fibers. However, individual fibers may instead be used.

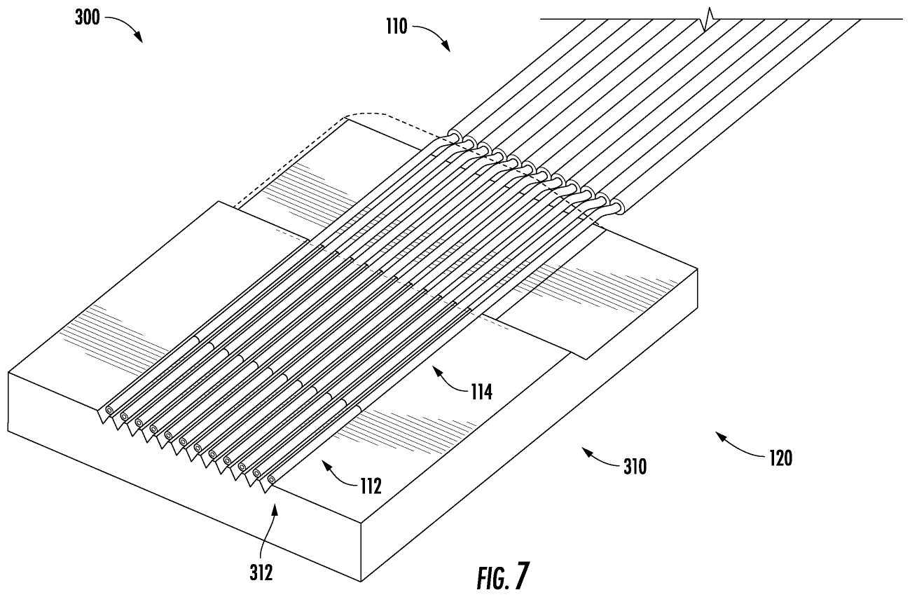

The plurality of mechanically spliced fibers may be situated in a plurality of ways within the grooves 312. For example, as illustrated in FIG. 6, the first optical fiber(s) 112 may protrude distally from the respective groove 312. In other embodiments, such as illustrated in FIG. 7 the first optical fiber(s) 112 may be recessed within the groove 312 so as not to extend distally from the groove 312. It is noted that in some embodiments it is contemplated that some fibers will protrude while other are recessed. Various combinations are contemplated and possible.

As noted above, in any of the embodiments described herein, determination of accurate quarter pitch length is necessary for allowing the first optical fiber 112 to act as a GRIN lens. Determination of an accurate quarter pitch length may be further described in U.S. Provisional Application No. 63/396,479, having attorney docket No. HI22-033PZUS//061262/09075, filed Aug. 9, 2022, hereby incorporated by reference in its entirety. In particular, to create an expanded beam connector, the fiber length of the second optical fiber needs to be accurately calculated. In general, models used to estimate the quarter-pitch length of a gradient-index lens fiber assume that the curvature of the core of the MMF is parabolic and that the refractive index profile may be represented by:

$${n}^{2} ( r ) = {n}_{0}^{2} [ 1 - 2 {{Δ}_{0} ( \frac{r}{a} )}^{2} ] , 0 \leq r \leq a \qquad ( 1 )$$

Where n₀ is the maximum refractive index, Δ₀ is the maximum relative refractive index, and a is the core radius (equal to one-half of the core diameter). The index distribution of a GRIN lens may be written:

$${n}^{2} ( r ) = {n}_{0}^{2} [ 1 - {( κ r )}^{2} + {{α}_{2} ( κ r )}^{4} + {{α}_{3} ( κ r )}^{6} + ⋯ ] , \qquad ( 2 )$$

with the quarter-pitch given by L_{1/4}=2π/4κ. Combining Equations (1) and (2) derives:

$${L}_{\frac{1}{4}} = \frac{π a}{2 \sqrt{2 {Δ}_{0}}} \qquad ( 3 )$$

Equation (1) is an approximation that does not accurately describe the refractive index profile that minimizes the delays of the skew modes propagating in the core of an MMF and will thus not yield an accurate quarter-pitch value. That refractive index profile is given by:

$${n}^{2} ( r ) = \frac{{n}_{0}^{2}}{[ 1 + \frac{2 {Δ}_{0}}{1 - 2 {Δ}_{0}} {( \frac{r}{a} )}^{α} ]} \qquad ( 4 )$$

for 0≤r≤a and where n₀=n_{cl}/\sqrt{1−2Δ₀}; α is the core curvature; and n_{cl} is the refractive index of the cladding.

The value of the core curvature a is typically greater than or equal to 1.9 and less than or equal to 2.2 for MMFs designed to have high modal bandwidth at an operating wavelength greater than or equal to 800 nm and less than or equal to 1600 nm. Since the curvature of a MMF core with an alpha value in this range is nearly parabolic, Equation (4) may be expanded with a Taylor series to obtain:

$${n}^{2} ( r ) = {n}_{0}^{2} [ 1 - \frac{2 {Δ}_{0}}{1 - 2 {Δ}_{0}} {( \frac{r}{a} )}^{α} ] {n}^{2} ( r ) = {n}_{0}^{2} [ 1 - \frac{2 {Δ}_{0}}{1 - 2 {Δ}_{0}} {{C}_{α} ( \frac{r}{a} )}^{2} ] , \qquad ( 5 )$$

where Cₐ is defined by:

$${C}_{α} = 1 + \frac{1}{a} {\int }_{0}^{a} ( α - 2 ) {( \frac{r}{a} )}^{( α - 2 )} ln ( \frac{r}{a} ) \qquad ( 6 )$$

for 0≤r≤a. The first quarter pitch of a small core MMF GRIN lens occurs at:

$${L}_{\frac{1}{4}} = \frac{π a}{2} \sqrt{\frac{1 - 2 {Δ}_{0}}{2 {C}_{α} {Δ}_{0}}} . \qquad ( 7 )$$

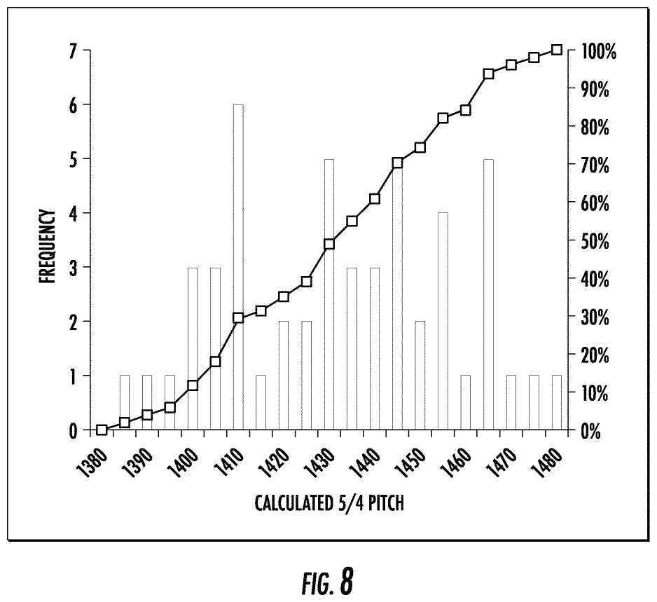

As noted above, it may be desired to ensure that the splice joint or connection 150 remains supported within the channel 124 of the support body 120, tray, or ferrule. For example, depending on the size of the transverse channel 140 a specific quarter pitch may be needed to allow for complete seating within the ferrule and support of the mechanical splice connection 150 within the channel 124. Such quarter pitch lengths may be 1/4, 3/4, 5/4, etc. pitch lengths. FIG. 8 is a plot of a distribution of 5/4 pitch lengths for calculated 5/4 pitch lengths from 21 randomly-selected production Corning ClearCurve® MMFs. As illustrated 5/4 pitch length may vary substantially between different fibers. Accordingly, it is noted that one advantage of using individual MMF stubs (e.g., individual cut lengths of fiber from a single spool) rather than a ribbonized array of fibers is that the optimum 5/4 length for a given reel of MMF can be determined from measurements of the refractive index profile of a sample of fiber from the spool used to create the quarter-pitch lengths of the first optical fiber 112. Accordingly, each MMF may be taken from the same spool meaning the quarter pitch length for each cut may be substantially (e.g., within +/−10 microns) the same, and need not be separately determined. However, it is noted that a multi-fiber ribbon such as a 12 or more fiber ribbon with a specially selected MMF having a tight distribution of refractive index may be used, though additional calculations may be needed. FIG. 9 illustrates that the 5/4 pitch length of a randomly selected MMF can vary by about ±50 microns from the mean value of about 1430 nm, which is too large to accurately ensure that the output of the MMF GRIN lens is collimated with low divergence.

Embodiments of the present disclosure may be further described by the following numbered clauses:

1. An expanded beam connector comprising: a mechanically spliced optical fiber comprising: a first optical fiber, wherein the first optical fiber is a multi-mode fiber having a first end, a second end, and a fiber length extending between the first end and the second end; and a second optical fiber mechanically spliced to the first end of the first optical fiber at a splice connection, the second optical fiber being a single-mode fiber; and a support body defining a fiber channel, wherein the splice connection is supported within the fiber channel, wherein the fiber length is an odd multiple of a quarter-pitch length and is greater than 0.1 mm and less than 5.0 mm.

2 The expanded beam connector of clause 1, further comprising a connector end face coupled to or part of the support body and positioned adjacent the second end of the first optical fiber.

3. The expanded beam connector of clause 2, wherein the connector end face is spaced from the second end of the first optical fiber a distance between 0 mm and about 5 mm.

4. The expanded beam connector of clause 3, wherein the support body defines transverse channel positioned between the fiber channel and the connector end face, and the first optical fiber is suspended within the transverse channel.

5. The expanded beam connector of any preceding clause, further comprising an adhesive coupling the first optical fiber to the second optical fiber at the splice connection.

6. The expanded beam connector of any preceding clause, wherein, at the quarter-pitch length, a wave transmission through the second optical fiber between the splice connection and the second end of the first optical fiber causes the wave transmission to expand or converge at the second end.

7. The expanded beam connector of any preceding clause, wherein the first optical fiber and the second optical fiber are joined via a butt joint.

8. A method of manufacturing an expanded beam connector, the method comprising: inserting a first length of a first optical fiber into a fiber channel formed within a support body; while within the fiber channel, cleaving the first length of the first optical fiber to provide a second length of the first optical fiber extending between a first end and a second end, the second length being a multiple of a quarter-pitch length; inserting a second optical fiber into the fiber channel to abut the second optical fiber with the second end of the first optical fiber at a splice connection; and sliding the first end of the first optical fiber to a final position with the second optical fiber such that the splice connection remains within the fiber channel at the final position.

9. The method of clause 8, further comprising cleaving the first end of the first optical fiber prior to inserting the first length of the first optical fiber into the fiber channel.

10. The method of any preceding clause, further comprising forming one or more markings on the first optical fiber to define a cleaving location, wherein inserting the first length of the first optical fiber into the fiber channel comprises leaving the one or more markings at a position outside of the fiber channel.

11. The method of any preceding clause, wherein the second length is an odd multiple of the quarter-pitch length.

12. The method of any preceding clause, further comprising supplying adhesive to the splice connection to fix the first optical fiber to the second optical fiber.

13. The method of any preceding clause, wherein the final position places the first end of the first optical fiber adjacent a connector end face.

14. The method of any preceding clause, wherein the first end of the first optical fiber is recessed within the fiber channel in the final position.

15. The method of any preceding clause, wherein the first end of the first optical fiber extends outside of the fiber channel in the final position.

16. An expanded beam connector comprising: an array of mechanically spliced optical fibers, each mechanically spliced optical fiber comprising: a first optical fiber, wherein the first optical fiber is a multi-mode fiber having a first end, a second end, and a fiber length extending between the first end and the second end; and a second optical fiber mechanically spliced to the first end of the first optical fiber at a splice connection, the second optical fiber being a single-mode fiber; and a support body defining an array of fiber channels, wherein the splice connection of each of the mechanically spliced optical fibers is supported within a respective fiber channel, wherein the fiber length is an odd multiple of a quarter-pitch length and is greater than 0.1 mm and less than 5.0 mm.

17. The expanded beam connector of clause 16, further comprising a connector end face coupled to or part of the support body and positioned adjacent the second end of the first optical fiber.

18. The expanded beam connector of clause 17, the connector end face is spaced from the second end of the first optical fiber a distance between 0 mm and about 5 mm.

19. The expanded beam connector of clause 18, wherein the support body defines a transverse channel positioned between the array of fiber channels and the connector end face, and the first optical fiber is suspended within the transverse channel.

20. The expanded beam connector of any of clauses 16-19, wherein, at the quarter-pitch length, a wave transmission through the second optical fiber between the splice connection and the second end of the first optical fiber causes the wave transmission to expand or converge at the second end.

21. The expanded beam connector of any of clauses 16-19, wherein the first optical fiber and the second optical fiber are joined via a butt joint.

It should now be understood that embodiments of the present disclosure are directed to expanded beam connectors and methods of manufacturing the same. In particular, in embodiments, a mechanically spliced optical fiber is formed from a first optical fiber and a second optical fiber. By using mechanical splicing, issues identified herein related to fusion splicing may be eliminated or avoided. Moreover, assembly as such expanded beam connectors may be more economical as opposed to traditional manufacturing processes.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. An expanded beam connector comprising:
a mechanically spliced optical fiber comprising:
a first optical fiber, wherein the first optical fiber is a multi-mode fiber having a first end, a second end, and a fiber length extending between the first end and the second end; and
a second optical fiber mechanically spliced to the first end of the first optical fiber at a splice connection, the second optical fiber being a single-mode fiber; and
a support body defining a fiber channel, wherein the splice connection is supported within the fiber channel, wherein:
the fiber length is an odd multiple of a quarter-pitch length, and
the support body defines a transverse channel positioned between the fiber channel and a connector end face and such that at least a portion of the first optical fiber is suspended within the transverse channel.

2. The expanded beam connector of claim 1, further comprising the connector end face is coupled to or part of the support body and positioned adjacent the second end of the first optical fiber.

3. The expanded beam connector of claim 1, wherein a proximally facing surface of the connector end face is spaced from the second end of the first optical fiber a distance between 0 mm and about 5 mm.

4. The expanded beam connector of claim 1, further comprising an adhesive coupling the first optical fiber to the second optical fiber at the splice connection.

5. The expanded beam connector of claim 1, wherein, at the quarter-pitch length, a wave transmission through the second optical fiber between the splice connection and the second end of the first optical fiber causes the wave transmission to expand or converge at the second end.

6. The expanded beam connector of claim 1, wherein the first optical fiber and the second optical fiber are joined via a butt joint.

7. The expanded beam connector of claim 1, wherein the fiber length is greater than 0.1 mm and less than 5.0 mm.

8. The expanded beam connector of claim 1, wherein the transverse channel extends to a depth greater than a position of the fiber channel.

9. The expanded beam connector claim 1, wherein the first optical fiber is abutted to a proximally facing surface of the connector end face.

10. The expanded beam connector claim 1, wherein the first optical fiber is spaced from a proximally facing surface of the connector end face by 2 mm or less.

11. A method of manufacturing an expanded beam connector, the method comprising:
inserting a first length of a first optical fiber into a fiber channel formed within a support body;
while within the fiber channel, cleaving the first length of the first optical fiber to provide a second length of the first optical fiber extending between a first end and a second end, the second length being a multiple of a quarter-pitch length;
inserting a second optical fiber into the fiber channel to abut the second optical fiber with the second end of the first optical fiber at a splice connection; and
sliding the first end of the first optical fiber to a final position with the second optical fiber such that the splice connection remains within the fiber channel at the final position and at least a portion of the first optical fiber is suspended within a transverse channel positioned between the fiber channel and a connector end face.

12. The method of claim 11, further comprising cleaving the first end of the first optical fiber prior to inserting the first length of the first optical fiber into the fiber channel.

13. The method of claim 11, further comprising forming one or more markings on the first optical fiber to define a cleaving location, wherein inserting the first length of the first optical fiber into the fiber channel comprises leaving the one or more markings at a position outside of the fiber channel.

14. The method of claim 11, wherein the second length is an odd multiple of the quarter-pitch length.

15. The method of claim 11, further comprising supplying adhesive to the splice connection to fix the first optical fiber to the second optical fiber.

16. The method of claim 11, wherein the transverse channel extends to a depth greater than a position of the fiber channel.

17. The method claim 11, wherein the first optical fiber is abutted to a proximally facing surface of the connector end face in the final position.

18. The method of claim 11, wherein the first optical fiber is spaced from a proximally facing surface of the connector end face by 2 mm or less in the final position.

19. The method of claim 11, further comprising separating the first optical fiber from a ribbonized array of fibers.

20. The method of claim 11, wherein the second length is a 5/4 pitch length.
